(19) United States
(12) Patent Application Publication
(10) Pub. No.: US 2021/0311505 A1
(43) Pub. Date: Oct. 7, 2021

(54) ASSISTED MOVEMENT METHOD AND DEVICE, AND MOVABLE PLATFORM

(71) Applicant: SZ DJI TECHNOLOGY CO., LTD., Shenzhen (CN)

(72) Inventor: Litian ZHANG, Shenzhen (CN)

(21) Appl. No.: 17/260,922

(22) PCT Filed: Jan. 23, 2018
(86) PCT No.: PCT/CN2018/073883

§ 371 Date: Jan. 15, 2021

(51) Int. Cl. G05D 1/10; B64C 39/02

(52) U.S. Cl. CPC G05D 1/106; B64C 2201/141; B64C 2201/027; B64C 39/024

(57) ABSTRACT

Embodiments of the present disclosure provide an assisted movement method and device, and a movable platform. The method includes generating an obstacle avoidance assistance instruction in a user control mode when the distance between the movable platform and the obstacle is less than a predetermined distance range; and, controlling the movement trajectory of the movable platform based on the control instruction entered by the user and the obstacle avoidance assistance instruction. The embodiments of the present disclosure improve the driving experience of the user.

### TECHNICAL FIELD

The present disclosure relates to the technical field of assisted control technology and, more specifically, to an assisted movement method and device, and a movable platform.

### BACKGROUND

As unmanned aerial vehicles (UAVs) become more popular, more and more people are starting to use UAVs for aerial photography. However, for users who have never used a UAV before, operating the UAV can be a problem, and a little carelessness can easily cause the UAV to crash. Therefore, some assisted driving technologies are needed for these users to help them avoid obstacles.

The conventional assisted driving technologies generally perform braking operations automatically when the UAV encounters an obstacle. Even in some scenarios where braking is not needed, the braking will still be performed, and the user's driving experience is poor.

### SUMMARY

The embodiments of the present disclosure provide an assisted movement method and device, and a movable platform to improve user experience.

In a first aspect, an embodiment of the present disclosure provide an assisted movement method including generating an obstacle avoidance assistance instruction in a user control mode when a distance to an obstacle is less than a predetermined distance range, and controlling a movement trajectory of a movable platform based on a control instruction input by a user and the obstacle avoidance assistance instruction.

In a second aspect, an embodiment of the present disclosure provide an assisted movement device including a processor and a memory storing program instructions. When executed by the processor, the program instructions cause the processor to generate an obstacle avoidance assistance instruction in a user control mode when a distance between a movable platform and an obstacle is less than a predetermined distance range, and control a movement trajectory of the movable platform based on a control instruction input by a user and the obstacle avoidance assistance instruction.

In a third aspect, an embodiment of the present disclosure provides a movable platform including a body, a power system disposed on the body for providing power to the movable platform, and the mobile device provided in the above second aspect.

In the embodiments of the present disclosure, when the movable platform is in the user control mode, an obstacle avoidance assistance instruction can be generated when the distance between the movable platform and the obstacle is less than a predetermined distance range, and the movement of the movable platform can be controlled based on the control instruction entered by the user and the obstacle avoidance assistance instruction. This allows the user to control the movement of the movable platform without considering obstacle avoidance, while ensuring the safe flight of the movable platform, avoiding the situation in conventional technology where the decision to stop immediately is made in response to predicting that the movable platform is about to hit an obstacle, thereby extending the flight distance of the movable platform.

### BRIEF DESCRIPTION OF THE DRAWINGS

FIG. 1 is a flowchart of an assisted movement method according to an embodiment of the present disclosure.

FIG. 2 is a schematic diagram of a scenario for generating of an obstacle avoidance assistance instruction according to an embodiment of the present disclosure.

FIG. 3 is a schematic diagram of another scenario for generating of the obstacle avoidance assistance instruction according to an embodiment of the present disclosure.

FIG. 4A and 4B are side views of a movable platform according to an embodiment of the present disclosure.

FIG. 5 is a schematic top view of the movable platform according to an embodiment of the present disclosure.

FIG. 6 is a flowchart a method for generating the obstacle avoidance assistance instruction according to an embodiment of the present disclosure.

FIG. 7 is a schematic diagram of a method for generating a movement track according to an embodiment of the present disclosure.

FIG. 8 is a schematic diagram of a speed change of the movable platform in any one of the left, right, and top directions according to an embodiment of the present disclosure.

FIG. 9 is a flowchart of a method for performing the process at 102 according to an embodiment of the present disclosure.

FIG. 10 is a schematic diagram of a plurality of movement trajectories according to an embodiment of the present disclosure.

FIG. 11 is a structural diagram of a movable device according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

It should be noted that, when one component is referred to as “fixed to” another component, it may be directly on another component or it is also possible that there is a third component between them. When one component is considered to “connect” another component, it may be directly connected to the other component or it is possible that there is a third component between them.

Unless otherwise defined, all the technical and scientific terms used in the present disclosure have the same or similar meanings as generally understood by one of ordinary skill in the art. As described in the present disclosure, the terms used in the specification of the present disclosure are intended to describe example embodiments, instead of limiting the present disclosure. The term “and/or” as used herein includes any and all combinations of one or more related listed items.

Exemplary embodiments will be described with reference to the accompanying drawings. In the case where there is no conflict between the exemplary embodiments, the features of the following embodiments and examples may be combined with each other.

An embodiment of the present disclosure provides an assisted movement method, which can be used to generate an obstacle avoidance assistance instruction when a movable platform is in a user control mode and the distance between the movable platform and the obstacle is less than a predetermined distance, and control the movement of the movable platform based on the obstacle avoidance assistance instruction and a control instruction entered by the user. Therefore, it is convention for users to control the movement of the movable platform without considering obstacle avoidance, while ensuring the safe flight of the movable platform, avoiding the situation in conventional technology where the decision to stop immediately is made in response to predicting that the movable platform is about to hit an obstacle, thereby extending the flight distance of the movable platform.

In the embodiments of the present disclosure, there are many trigger method for generating the obstacle avoidance assistance instruction.

In some embodiments, the movable platform may store map information of the current environment. When the movable platform detects that the distance between the current position and the obstacle is less than the predetermined distance, predicts that the movable platform will hit the obstacle within a predetermined amount of time at the current speed, predicts that the distance between the distance between the movable platform and the obstacle is less than the predetermined distance and the current speed direction of the movable platform is facing the obstacle, or after an assisted obstacle avoidance mode of the movable platform is turned on, the movable platform may start to perform the operation of generating the obstacle avoidance assistance instruction.

In some embodiments, the map information of the current environment stored in the movable platform may be downloaded from a server or obtained based on the detection data of the sensors on the movable platform. In some embodiments, the sensor may include a vision sensor (such as a binocular camera, a monocular camera) and/or a distance sensor (such as a TOF camera, a lidar). For example, in an embodiment where the movable platform is a UAV, the map information may be obtained by the UAV based on the detection data of the sensors in the same flight or in different flights, where the flight of the UAV between adjacent take-off and landing may be regarded as a flight.

In some embodiments, the activation of the assisted obstacle avoidance mode on the movable platform may be triggered based on an instruction entered by the user. For example, physical buttons or virtual buttons may be disposed on the operation interface used by the user to control the movable platform, or the assisted obstacle avoidance mode may be disposed on the operation interface. When the user's operations of the physical button, virtual button, or the assisted obstacle avoidance mode is detected, the movable platform may determine to enter the assisted obstacle avoidance mode of the movable platform.

In some embodiments, the movable platform may activate the assisted obstacle avoidance mode automatically by default when it detects that the distance between the current position and the obstacle is less than the predetermined distance, predicts that it will hit the obstacle within the predetermined amount of time at the current, or predicts that the distance between the current position and the obstacle is less than the predetermined distance and the current speed direction of the movable platform is facing the obstacle. In some embodiments, the user may choose to turn off the default automatic assisted obstacle avoidance mode function.

In some embodiments, the obstacle avoidance assistance instruction may always be generated during the movement of the movable platform, but the movement of the movable platform may be controlled based on the obstacle avoidance assistance instruction only under certain conditions.

In the embodiments of the present disclosure, there are many methods for generating the obstacle avoidance assistance instruction.

In some embodiments, the movable platform may determine a target direction of the movable platform based on the control instruction currently entered by the user, generate at least one predicted trajectory that can bypass the obstacle and move toward the target direction, determine a target predicted trajectory from the at least one predicted trajectory, generate the obstacle avoidance assistance instruction to enable the movable platform to move along the target predicted trajectory based on the target predicted trajectory and the control instruction entered by the user, and control the movement of the movable platform based on the obstacle avoidance assistance instruction and the control instruction entered by the user.

In some embodiments, the target direction may be the same as the speed direction of the movable platform corresponding to the control instruction currently entered by the user. Alternatively, the movable platform may predict the control instruction entered by the user in a certain time window in the future based on the control instruction currently entered by the user, and determine the target direction of the movable platform based on the predicted control instruction. In some embodiments, the target direction may be the same as the speed direction of the movable platform corresponding to the predicted control instruction. It can be understood that when the control instruction entered by the user changes, the obstacle avoidance assistance instruction may change accordingly.

It should be noted that the speed direction of the movable platform corresponding to the control instruction mentioned in the present disclosure may refer to the moving direction of the movable platform when the movable platform is controlled to movement based on the instruction when it is stationary.

In some embodiments, the movable platform may predict the control instruction entered by the user in a certain time window in the future based on the control instruction entered by the user, and generate various obstacle avoidance assistance instructions based on specific rules based on the control instruction entered by the user. Based on the current state of the movement and at least one of the following instructions of the control instruction currently entered by the user, the current obstacle avoidance assistance instruction used to control the movement of the movable platform, the predicted control instruction entered by the user in a certain time window in the future, and the various alternative obstacle avoidance assistance instructions generated for a certain time window in the future, the movable platform may separately predict a plurality of trajectories of the movable platform under different instructions or a combination of instructions in a certain time window in the future. The plurality of predicted trajectories may be used as alternative trajectories. A target movement trajectory may be determined form the plurality of candidate movement trajectories based on a predetermined condition, and the movement of the movable platform may be controlled within a certain time window in the future based on the obstacle avoidance assistance instruction corresponding to the target movement trajectory.

It should be noted that, in some scenarios, for example, in a scenario where the movable platform does not hit the obstacle within a certain period of time based on the control instruction entered by the user, there may not be an obstacle avoidance assistance instruction in the instruction corresponding to the target movement trajectory. Then, in a certain time window in the future, the movement of the movable platform is controlled by based on the control instruction entered by the user, and the obstacle avoidance assistance instruction generated may not be used to control the movable platform.

There are many method for the movable platform to predict the control instruction that the user will input in a certain time window in the future. For example, the movable platform may regard the currently input control instruction as the predicted control instruction input in a certain time window in the future. In another example, the user may enter the control instruction through a rocker on a remote control. The amount of rocker entered by the user may include the amount of roll, pitch, yaw, and throttle (thr). The physical model of the remote control rocker may be established through the Kalman filter, and the physical mode may add factors such as rocker spring, resistance, etc.

There are many method for the movable platform to generate the candidate movement trajectories. In some embodiments, the movable platform may predict at least one of the following movement trajectories based on the current movement state.

1. The movement trajectory of the movable platform in a certain window of time in the future based on the control of the predicted control instruction entered by the user in in a certain window of time in the future.

2. The movement trajectory of the movable platform in a certain window of time in the future based on the control of the current obstacle avoidance assistance instruction used to control the movement of the movable platform and the predicted control instruction entered by the user in a certain window of time in the future.

3. The movement trajectory of the movable platform in a certain window of time in the future based on the control of the generated instructions for each of the plurality of candidate obstacle avoidance assistance instructions within in a certain window of time in the future and the predicted control instruction entered by the user within the in a certain window of time in the future.

At least one movement trajectory may be obtained as the candidate movement trajectory.

In some embodiments, regardless of the triggering method of the obstacle avoidance assistance instruction, the movable platform may generate the obstacle avoidance assistance instruction when the movable platform and the obstacle are less than the predetermined distance. In addition, among the adopted obstacle avoidance assistance instructions, when the obstacle avoidance assistance instructions are used to control the movement of the movable platform, the obstacle avoidance assistance instructions may increase the speed component of the movable platform in a first direction, where the first direction may refer to one of the directions perpendicular to the direction of the movable platform toward the obstacle.

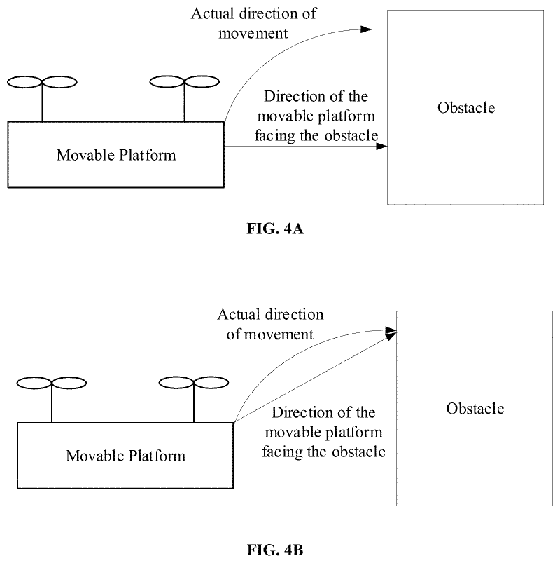

In some embodiments, the direction of the movable platform toward the obstacle may be the direction of the shortest connection line between the movable platform and the obstacle, or the direction of the connection line between a certain point on the movable platform and a certain point of the obstacle, which is not limited herein. Take FIG. 4A and FIG. 4B, which are side views of a movable platform according to an embodiment of the present disclosure, as an example, as shown in FIG. 4A and FIG. 4B, the direction of the movable platform toward the obstacle may be defined as the direction in which the movable platform moves toward the obstacle in the horizontal direction, or the linear direction of the movable platform moving toward the obstacle, however, it is not limited to the definition shown in FIG. 4A and FIG. 4B.

In some embodiments, the obstacle avoidance assistance instruction may increase the speed component of the movable platform along the first direction, which means that the speed direction of the movable platform corresponding to the obstacle avoidance assistance instruction may be the first direction. Or, it means that when the movable platform moves under the control of an control instruction entered by the user, when the obstacle avoidance assistance instruction is added, the speed component of the movable platform may increase in the first direction. The movable platform may change the original movement trajectory (i.e., the movement trajectory of the movable platform only under the control of the control instruction entered by the user) after adding the control of the obstacle avoidance assistance instruction. Take the second scenario as an example.

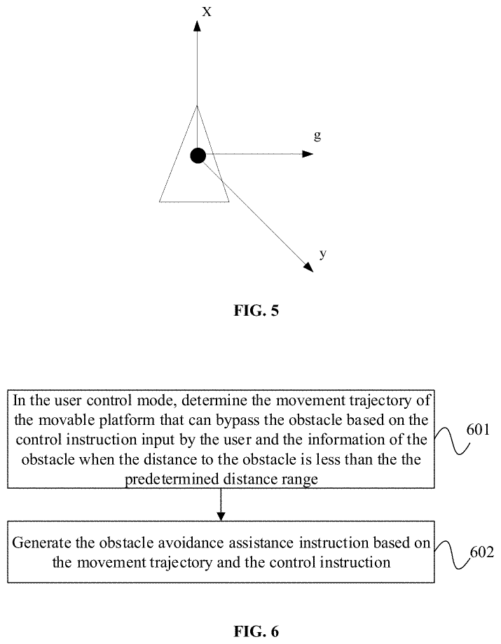

For example, FIG. 5 is a schematic top view of the movable platform according to an embodiment of the present disclosure. As shown in FIG. 5, direction x is the direction of the movable platform toward the obstacle, direction y is the speed direction applied by the obstacle avoidance assistance instruction, direction y and direction x are at an angle, and the speed in direction y can be decomposed to obtain s speed component perpendicular to direction x, that is, the speed component in direction g in FIG. 5. The movable platform may change he current movement trajectory under the action of the speed component in direction g. In this embodiment, the angle between the speed in direction y and the speed in direction x is greater than 90° as an example, and the speed in direction y can be decomposed into a speed component perpendicular to direction x and a speed component opposite to direction x, where the speed component perpendicular to direction x may change the movement trajectory of the movable platform, and the speed component opposite to direction x may reduce or offset the speed component of the movable platform toward the obstacle (i.e., the speed component in direction x) caused by the user's control instruction, thereby achieving the purpose of avoiding the obstacle or allowing the movable platform to move for a period of time before the collision. Obviously, FIG. 5 is merely an example, rather than a limitation of the present disclosure.

The assisted movement method in the embodiments of the present disclosure will be described below with an example.

An embodiment of the present disclosure provides an assisted movement method. FIG. 1 is a flowchart of an assisted movement method according to an embodiment of the present disclosure. As shown in FIG. 1, the method includes the following processes.

101, in the user control mode, generating the obstacle avoidance assistance instruction when the distance to the obstacle is less than the predetermined distance.

The user control mode related to this embodiment may refer to a control mode in which the user can control the movement trajectory and/or movement state of the movable platform through a handheld remote control or other control devices. In some embodiments, the movable platform related to this embodiment may be a device with a certain processing capability, such as a UAV or a car, and can be controlled by a control device.

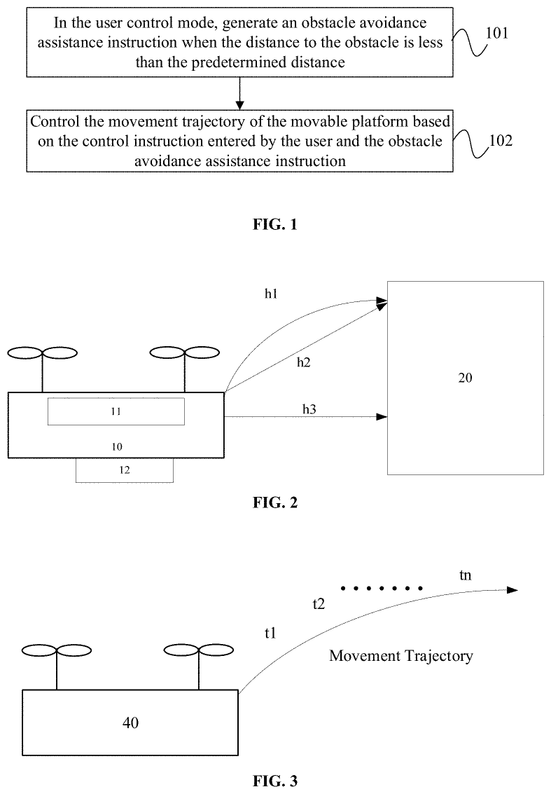

For example, FIG. 2 is a schematic diagram of a scenario for generating of an obstacle avoidance assistance instruction according to an embodiment of the present disclosure. FIG. 2 includes a movable platform 10 and an obstacle 20, where the movable platform 10 includes a processor 11 and a detection device 12. When the detection device 12 detects that the distance between the movable platform 10 and the obstacle 20 is less than the predetermined distance, the processor 11 can be triggered to generate an obstacle avoidance assistance instruction. In some embodiments, the distance between the movable platform 10 and the obstacle 20 may be specifically referred to as a moving distance h1 before the collision between the movable platform 10 and the obstacle 20, or, a linear distance h2 between the movable platform 10 and its collision point with the obstacle 20, or, a vertical distance h3 between the movable platform 10 and the obstacle 20 in the horizontal direction. When the distance between the movable platform 10 and the obstacle 20 is less than the predetermined distance, one or more obstacle avoidance assistance instructions may be generated.

Further, when generating the obstacle avoidance assistance instruction, the processing method of the processor 11 may include the following two methods.

In one processing method, the processor 11 may determine whether to generate an obstacle avoidance assistance instruction based on the control instruction entered by the user. For example, when the processor 11 determines that the control instruction entered by the user causes a collision risk between the movable platform 10 and the obstacle 20, it may generate an obstacle avoidance assistance instruction to change the movement trajectory of the movable platform 10 through the obstacle avoidance assistance instruction. If it is determined that the control instruction entered by the user will not cause a collision, no obstacle avoidance assistance instruction may be generated.

In another processing method, when the detection device 12 detects that the distance between the movable platform 10 and the obstacle 20 is less than the predetermined distance, the processor 11 may directly generate an obstacle avoidance assistance instruction without detecting whether the control instruction entered by the user will cause a collision.

Obviously, FIG. 2 is merely a generation scenario of the obstacle avoidance assistance instruction according to an embodiment of the present disclosure, instead of all the scenarios. In fact, in other embodiments, the obstacle 20 may also be generated in other scenarios. For example, FIG. 3 is a schematic diagram of another scenario for generating of the obstacle avoidance assistance instruction according to an embodiment of the present disclosure. In this scenario, a movable platform 40 can generate the obstacle avoidance assistance instructions at times, t1, t2 . . . tn, where adjacent times in t1, t2 . . . tn may be equally spaced or unequally spaces, that is, the settings of t1, t2 . . . tn may be arbitrary.

102, controlling the movement trajectory of the movable platform based on the control instruction entered by the user and the obstacle avoidance assistance instruction.

The control instruction involved in this embodiment may include at least one of the roll rocker amount (roll), the pitch rocker amount (pitch), the yaw rocker amount (yaw), and the throttle rocker amount (thr).

In this embodiment, controlling the movement trajectory of the movable platform based on the control instruction entered by the user and the obstacle avoidance assistance instruction may include using the control instruction entered by the user and the obstacle avoidance assistance instruction as the input of a predetermined model, and obtaining the movement trajectories of the movable platform through the prediction of the predetermined model. Further, a movement trajectory may be selected form the obtained movement trajectories, such that the movable platform may move along the movement trajectory.

An example will be used to describe the process of selecting a movement trajectory from the obtained movement trajectories to control the movement of the movable platform.

For example, when the current movement control of the movable platform includes the obstacle avoidance assistance instruction (hereinafter referred to as the current obstacle avoidance assistance instruction), movement trajectories from the one or more movement trajectories obtained by the above prediction whose trajectory direction is the same as the movement trajectory obtained by the current obstacle avoidance assistance instruction (hereinafter referred to as the current movement trajectory) may be selected. For example, the movement trajectory obtained by the current obstacle avoidance assistance instruction may be on the upper side of the body, and the movement trajectories located on the upper side of the body may be selected from the one or more movement trajectories obtained by prediction. Of course, this is merely an example, not the only limitation of the embodiment. Further, the selected movement trajectories may be further filtered to obtain the movement trajectories whose movable distances are longer than the movable distance of the current movement trajectory of the movable platform by a predetermined distance (e.g., 2 m) as the candidate movement trajectories. In some embodiments, the movable distance may refer to the distance that the movable platform can move before a collision.

When the current movement control of the movable platform does not include the obstacle avoidance assistance instruction, one or more movement trajectories obtained by the above prediction may be directly filtered to obtain a movement trajectories whose movable distances are longer than the movable distance of the current movement trajectory of the movable platform by the predetermined distance as the candidate movement trajectories.

Further, after obtaining the alternative movement trajectories, the movement trajectory with the longest distance from the candidate movement trajectories, and the movement trajectories whose movable distances are 1.5 m shorter than the longest movable distance may be filtered out. Then, from the selected movement trajectories, the movement trajectory with the least energy consumption may be selected as the best candidate movement trajectory. When there is no movement trajectory that meets the above conditions, the best candidate movement trajectory may be determined as null.

When the obstacle avoidance assistance instruction is included in the current movement control of the movable platform, if the best candidate movement trajectory is null, and the movable distance of the movement trajectory of the movable platform when there is no obstacle avoidance assistance instruction is longer than the predetermined distance of the movable distance of the movement trajectory under the obstacle avoidance assistance instruction, then the movable platform may be controlled to move along the movement trajectory when there is no obstacle avoidance assistance instruction, otherwise the movable platform may still move along the current movement trajectory. If the best candidate movement trajectory is not null, and the movable distance of the movement trajectory of the movable platform when there is no obstacle avoidance assistance instruction is longer than the movable distance of the best candidate movement trajectory, the movable platform may be controlled to move along the movement trajectory when there is no obstacle avoidance assistance instruction, otherwise the movable platform may by controlled to move along the best candidate movement trajectory.

When the current movement control of the movable platform does not include the obstacle avoidance assistance instruction, if the best candidate movement trajectory is null, or the best candidate movement trajectory is not null, but the movable distance of the current movement trajectory is longer than the movable distance of the best candidate movement trajectory, the movable platform may be controlled to move along the current movement trajectory. If the best candidate movement trajectory is not null and the movable distance of the current movement trajectory is shorter than the movable distance of the best candidate movement trajectory, the movable platform may be controlled to move along the best candidate movement trajectory.

Obviously, those skilled in the art would understand that the above example are merely illustrative for clarity and are not the limitations of the present disclosure.

In this embodiment, in the user control mode, when the distance between the movable platform and the obstacle is less than the predetermined distance, an obstacle avoidance assistance instruction may be generated, and the movement trajectory of the movable platform may be controlled based on the control instruction entered by the user and the obstacle avoidance assistance instruction. As such, in the user control mode, active obstacle avoidance of the movable platform can also be realized, such that the movable platform can avoid obstacles under the combined action of the control instruction entered by the user and the obstacle avoidance assistance instruction, or move for an additional period of time when the obstacles cannot be avoided, instead of performing the braking operation as soon as an obstacle is encountered, thereby improving the safety of the movement of the movable platform and the user experience.

The embodiment of FIG. 1 is further optimized and expanded by the following embodiment.

FIG. 6 is a flowchart a method for generating the obstacle avoidance assistance instruction according to an embodiment of the present disclosure. As shown in FIG. 6, based on the above embodiments, the method for generating the obstacle avoidance assistance instruction may include the following processes.

601, in the user control mode, determining the movement trajectory of the movable platform that can bypass the obstacle based on the control instruction entered by the user and the information of the obstacle when the distance to the obstacle is less than the the predetermined distance range.

The obstacle information involved in this embodiment may include, but is not limited to, the position, size, and shape of the obstacle. In some embodiments, the obstacle information may be obtained from a pre-stored map, or by taking an image of the obstacle and calculating the obstacle information based on a predetermined image detection algorithm. For example, the edge of the obstacle image may be detected by an edge detection algorithm first, and then the coordinates of a point outside the obstacle image may be determined based on the coordinates of the point on the edge of the obstacle image. Subsequently, based on the coordinates of the point outside the obstacle image and the current position of the movable platform, a movement trajectory that can bypass the obstacle can be obtained. Similarly, a plurality of trajectories may be obtained that can bypass the obstacle. Of course, this is merely an example for illustrate, and it is not a limitation to the present disclosure.

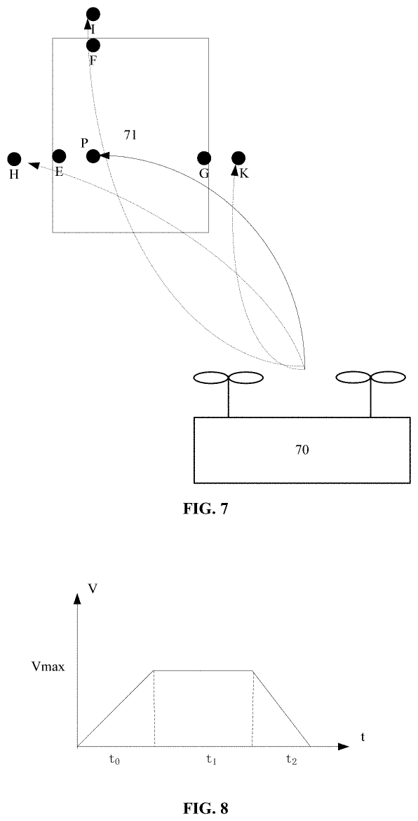

For example, FIG. 7 is a schematic diagram of a method for generating a movement track according to an embodiment of the present disclosure. As shown in FIG. 7, assume that under the action of the control instruction entered by the user, a movable platform 70 will collide with a point P on an obstacle 71, where points E, F, and G are points determined to be positioned on the edge of the obstacle based on the point P. Point E is positioned on the left side of the point P, point F is positioned on the upper side of the point P, and point G is positioned on the right side of the point P. Then one or more points positioned outside the obstacle 71 may be determined based on the points E, F, and G. Assume that a point H is determined based on the point E, a point I is determined based on the point F, and a point K is determined based on the point G, then based on points H, I, and K and the current position of the obstacle 71, three possible movement trajectories that can bypass the obstacle 71 may be determined. Of course, this is merely an example for illustration, not a limitation to the present disclosure.

602, generating the obstacle avoidance assistance instruction based on the movement trajectory and the control instruction.

In this embodiment, generating the obstacle avoidance assistance instruction based on the movement trajectory and the control instruction may include the following methods.

In one method, after obtaining one or more movement trajectories that can bypass the obstacle, the one or more movement trajectories and/or the current movement trajectory of the movable platform may be displayed, and the selectable operations of the movement trajectories may be provided on the display interface. After the user selects the target movement trajectory, based on the control instruction entered by the user, the obstacle avoidance assistance instruction that needs to be added to obtain the target movement trajectory may be determined. For example, the control instruction entered by the user may be used to control the movable platform to move in the direction of 50° southeast of the current direction of movement, and the target movement trajectory may be to move in the direction of 30° southeast of the current direction of movement, then the obstacle avoidance assistance instruction may be determined such that the movable platform will move from 50° southeast of the current direction of movement to 30° southeast of the current direction of movement. Of course, this is merely an example for illustration, not a limitation to the present disclosure.

In another method, for each movement trajectory that can bypass the obstacle, the obstacle avoidance assistance instruction that needs to be added to obtain each movement trajectory may be determined based on the control instruction entered by the user.

Obviously, the embodiment of FIG. 6 is merely an implementation method for generating the obstacle avoidance assistance instruction, and is not a limitation on the method of generating the obstacle avoidance assistance instruction. In fact, in actual applications, one or more obstacle avoidance assistance instructions may also be generated directly based on the control instruction entered by the user.

The following uses an embodiment as an example for description. After determining the movement direction corresponding to the control instruction entered by the user, based on this direction, the direction of action of the obstacle avoidance assistance instruction may be divided into three directions, namely the left, right, and top of the body. In each direction, the obstacle avoidance assistance instruction may be a speed instruction towards that direction. More specifically, FIG. 8 is a schematic diagram of a speed change of the movable platform in any one of the left, right, and top directions according to an embodiment of the present disclosure. As shown in FIG. 8, under the action of the obstacle avoidance assistance instruction, the speed of the movable platform in the direction shown in FIG. 8 increases from zero to a speed Vmax with a length of time t₀, maintains the speed Vmax unchanged during a length of time t₁, and decreases from the speed Vmax to zero again with a length of time t₂. A set of Vmax, t₀, t₁, and t₂ may correspond to an obstacle avoidance assistance instruction. By changing the value of any one or more or Vmax, t₀, t₁, and t₂, a plurality of obstacle avoidance assistance instructions corresponding to the direction may be generated, thereby obtaining a plurality of movement trajectories in this direction. The generation method of the obstacle avoidance assistance instructions in other directions is similar to this, and will not be repeated here.

Those skilled in the art would obviously understand that the direction of action of the obstacle avoidance assistance instruction may not be limited to three directions of left, right, and top of the body, but can be set freely based on needs.

In this embodiment, in the user control mode, based on the control instruction entered by the user and the obstacle information, the movement trajectories for the movable platform to bypass the obstacle can be determined when the distance between the movable platform and the obstacle is less than the predetermined distance range, and the corresponding obstacle avoidance assistance instructions can be generated based on the trajectories and the control instruction entered by the user. As such, the movable platform can bypass the obstacle under the action of the obstacle avoidance assistance instructions, thereby realizing assisted obstacle avoidance in the user control mode, and improving the safety and user experience of the movable platform during the movement.

FIG. 9 is a flowchart of a method for performing the process at 102 according to an embodiment of the present disclosure. In the embodiment of FIG. 9, in the process at 101, in response to detecting that the distance between the movable platform and the obstacle is within the predetermined distance range, one or more obstacle avoidance assistance instructions may be generated directly based on the control instruction entered by the user. In some embodiments, the specific generation method of the obstacle avoidance assistance instruction may be similar to the example described above by taking the model 230 UAV as an example, which will not be repeated here. As shown in FIG. 9, on the base of the embodiment in FIG. 1, the process at 102 may be extended to the following processes.

901, based on a first control instruction currently entered by the user, predicting a second control instruction that the user may input within a predetermined period of time after the input of the first control instruction.

In this embodiment, the control instruction entered by the user may include the first control instruction current entered by the user and the second control instruction predicted based on the first control instruction. In some embodiments, the second control instruction may be obtained through the output of an instruction predetermined model by inputting the first control instruction into a predetermined instruction prediction model. The instruction prediction model may be established and obtained by any method in conventional technology, which is not specifically limited in this embodiment.

902, controlling the movement trajectory of the movable platform based on the second control instruction and the obstacle avoidance assistance instruction.

More specifically, after obtaining the second control instruction, the movement state of the movable platform corresponding to the first control instruction may be used as the initial state of a trajectory prediction model based on the predetermined trajectory prediction model. The second control instruction and the obstacle avoidance assistance instruction may be used as the input of the trajectory prediction model to predict and obtain the movement trajectory corresponding to each obstacle avoidance assistance instruction. That is, the above content can be exemplarily expressed as predicting one or more movement trajectories of the movable platform based on the first control instruction, the second control instruction, and the obstacle avoidance assistance instruction.

In some embodiments, if the current movement of the movable platform includes the obstacle avoidance assistance instructions (hereinafter referred to as the current obstacle avoidance assistance instructions), then the movement state of the movable platform corresponding to the first control instruction may also be used as the initial state of the trajectory prediction model. The second control instruction and the current obstacle avoidance assistance instruction may be used as the input of the trajectory prediction model, and the current movement trajectory of the movable platform may be obtained based on the prediction of the trajectory prediction model. Alternatively, when the obstacle avoidance assistance instruction is not included in the current movement of the movable platform, the movement state of the movable platform corresponding to the control instruction may be used as the initial state of the trajectory prediction model, the second control instruction may be used as input to the trajectory prediction model, and the current trajectory of the movable platform may be predicted and obtained based on the trajectory prediction model.

There are many methods for the movable platform to determine a target movement trajectory from the predicted candidate movement trajectories. For example, based on the map information of the current environment stored in the movable platform, the movable platform may determine the target movement trajectory from one or more candidate movement trajectories of the movable platform obtained by prediction based on at least one of the following selection conditions, and control the movement of the movable platform based on the target movement trajectory.

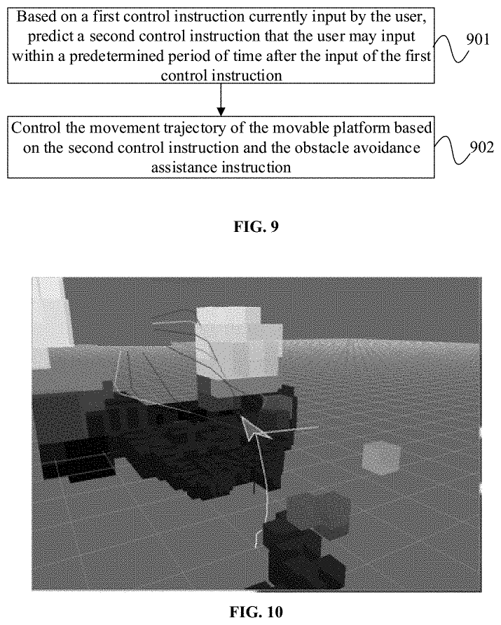

In one implementation, one or more predicted movement trajectories may be displayed first. FIG. 10 is a schematic diagram of a plurality of movement trajectories according to an embodiment of the present disclosure. As shown in FIG. 10, in this implementation method, a user-operable interface is provided, such that the user can select the movement trajectory of the movable platform from the plurality of displayed movement trajectories. When the user's selection operation is detection, the movement of the movable platform may be controlled based on the movement trajectory selected by the user.

In another implementation, a movement trajectory may be selected from one or more movement trajectories obtained above based on a predetermined trajectory selection strategy, such that the movable platform may move along the movement trajectory. When considering energy factors and moving distance factors, a movement trajectory with the movable distance greater than a first predetermined threshold that consuming the least energy (including the energy consumed by the obstacle avoidance assistance instructions and/or the energy consumed by the movable platform movement) may be selected, and the movable platform may be controlled to move along the movement trajectory. Alternatively, a movement trajectory with the greatest movable distance and the energy consumption less than a second predetermined threshold may be selected. Or, first from one or more movement trajectories obtained by the above prediction, a movement trajectory with a movable distance greater than the first predetermined threshold and/or the energy consumption less than the second predetermined threshold may be obtained, then the movable platform may be controlled to move based on the obtained movement trajectory whose movable distance is greater than or equal to the movable distance of the current movement trajectory of movable platform. For example, when considering the optimal configuration of energy, the movement trajectory whose movable distance is greater than or equal to the current movement trajectory of the movable platform with the least energy consumption may be selected to be displayed, and the movable platform may be controlled to move based on the movement trajectory. Alternatively, when considering the interactivity, the movement trajectory of the predicted movement trajectory whose movable distance is greater than or equal to the movable distance of the current movement trajectory of the movable platform may also be displayed, and the movement of the movable platform may be controlled based on the movement trajectory selected by the user.

Further, if the movable distance obtained above is greater than the first predetermined threshold and/or the movable distance of the movement trajectory whose energy consumption is less than the second predetermined threshold is less than the movable distance of the current movement trajectory of the movable platform, then the movable platform may be controlled to perform the braking operation to avoid a collision.

Obviously, the embodiment in FIG. 9 is merely an implementation method of the process at 102 provided in the embodiments of the present disclosure, rather than all methods for implementing the process at 102. In fact, it is also possible to directly use the first control instruction and the obstacle avoidance assistance instruction entered by the user as input, and generate one or more movement trajectories of the movable platform based on the predetermined model. Then a movement trajectory may be selected from the one or more generated movement trajectories based on a method similar to the embodiment in FIG. 9, and the movable platform may be controlled to move along the movement trajectory. That is, it may be expressed as an example of controlling the movement trajectory of the movable platform based on the first control instruction and the obstacle avoidance assistance instruction current entered by the user.

In this embodiment, based on the first control instruction currently entered by the user, the second control instruction that the user may input within a predetermined period of time after the input of the first control instruction can be predicted. Based on the first control instruction, the second control instruction, and the obstacle avoidance assistance instruction, one or more movement trajectories of the movable platform can be predicted. Subsequently, the movement of the movable platform can be controlled based on the one of the one or more movement trajectory obtained by prediction, thereby making the generated movement trajectories more reliable without causing the currently generated movement trajectory to lose the obstacle avoidance effort because the user inputs other control instructions within the predetermined period of time after the first control instruction is input. In addition, in this embodiment, since one or more obstacle avoidance assistance instructions can be first obtained based on the control instruction entered by the user, and then the movement trajectory of the movable platform can be predicted based on the obtained one or more obstacle avoidance assistance instructions and the control instruction entered by the user, therefore, this embodiment is more flexible in generating the obstacle avoidance assistance instructions.

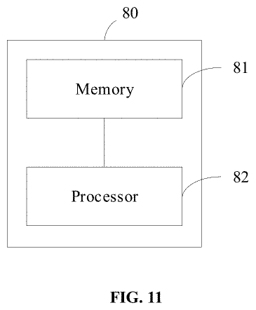

An embodiment of the present disclosure provides a movable device. FIG. 11 is a structural diagram of a movable device according to an embodiment of the present disclosure. As shown in FIG. 11, a movable device 80 includes a memory 81 and a processor 82. The memory 81 stores program codes, and the processor 82 is configured execute the program codes in the memory. When the program codes are executed, the processor 82 is caused to, in the user control mode, generate the obstacle avoidance assistance instruction when the distance between the movable platform and the obstacle is less than the predetermined distance, and control the movement trajectory of the movable platform based on the control instruction entered by the user and the obstacle avoidance assistance instruction.

In some embodiments, the obstacle avoidance assistance instruction generated by the processor 82 may be used to increase the speed component of the movable platform in the first direction. In some embodiments, the first direction may be perpendicular to the direction in which the movable platform faces the obstacle.

In some embodiments, the obstacle avoidance assistance instruction generated by the obstacle avoidance assistance instruction may be used to reduce or offset the speed component of the movable platform toward the obstacle caused by the control instruction.

In some embodiments, when generating the obstacle avoidance assistance instruction, the processor 82 may be configured to, in the user control mode, determine the movement trajectory of the movable platform that can bypass the obstacle based on the control instruction entered by the user and the obstacle avoidance assistance instruction when the distance between the movable platform and the obstacle is less than the predetermined distance; and, generate the obstacle avoidance assistance instruction based on the movement trajectory of the control instruction.

In some embodiments, when the program codes are executed, the processor 82 may be further caused to send the current movement trajectory of the movable platform and/or the movement trajectory of the movable platform that can bypass the obstacle to a ground station for display.

In some embodiments, when generating the obstacle avoidance assistance instruction, the processor 82 may be configured to, in the user control mode, generate one or more obstacle avoidance assistance instructions based on the control instruction entered by the user when the distance between the movable platform and the obstacle is less than the predetermined distance range.

When controlling the movement trajectory of the movable platform based on the control instruction entered by the user and the obstacle avoidance assistance instruction, the processor 82 may be configured to control the movement trajectory of the movable platform based on the control instruction entered by the user and the obstacle avoidance assistance instruction.

In some embodiments, when controlling the movement trajectory of the movable platform based on the control instruction entered by the user and the obstacle avoidance assistance instruction, the processor 82 may be configured to, based on a first control instruction current entered by the user, predict a second control instruction that the user may input within a predetermined period of time after the input of the first control instruction; and control the movement trajectory of the movable platform based on the second control instruction and the obstacle avoidance assistance instruction.

In some embodiments, when controlling the movement trajectory of the movable platform based on second control instruction and the obstacle avoidance assistance instruction, the processor 82 may be configured to predict one or more movement trajectories of the movable platform based on the first control instruction, the second control instruction, and the obstacle avoidance assistance instruction; and control the movable platform to move based on one of the one or more movement trajectories.

In some embodiments, when the program codes are executed, the processor 82 may be caused to send the one or more movement trajectories to the ground station for display.

In some embodiments, when the program codes are executed, the processor 82 may be caused to obtain the user's selection operation on the one or more movement trajectories; and control the movement of the movable platform based on the movement trajectory selected by the user.

In some embodiments, when controlling the movement of the movable platform based on one of the one or more movement trajectories, the processor 82 may be configured to control the movable platform to move based on the movement trajectory whose movable distance is greater than the first predetermined threshold with the least energy consumption from the one or more movement trajectories.

In some embodiments, when controlling the movement of the movable platform based on one of the one or more movement trajectories, the processor 82 may be configured to control the movable platform to move based on the movement trajectory with the greatest movable distance and the energy consumption being less than the second predetermined threshold from the one or more movement trajectories.

In some embodiments, when controlling the movement of the movable platform based on one of the one or more movement trajectories, the processor 82 may be configured to obtain the movement trajectory whose movable distance is greater than the first predetermined threshold and/or the energy consumption is less than the second predetermined threshold from the one or more movement trajectories; and, control the movable platform to move based on the movement trajectory whose movable distance in the movement trajectory is greater than or equal to the movable distance of the current movement trajectory of the movable platform.

In some embodiments, when the program codes are executed, the processor 82 may be further caused to send the movement trajectory whose movable distance is greater than or equal to the movable distance of the current movement trajectory of the movable platform in the movement trajectories to the ground station for display.

In some embodiments, when controlling the movable platform to move based on the movement trajectory whose movable distance in the movement trajectory is greater than or equal to the movable distance of the current movement trajectory of the movable platform, the processor 82 may be configured to control the movable platform to move based on the movement trajectory in the movement trajectories whose movable distance is greater than or equal to the current movement trajectory of the movable platform and consumes the least energy.

In some embodiments, when the program codes are executed, the processor 82 may be further caused to send the movement trajectory whose movable distance is greater than or equal to the current movement trajectory of the movable platform and consumes the least energy in the movement trajectories to the ground station for display.

In some embodiments, when the program codes are executed, the processor 82 may be further caused to control the movable platform to perform the braking operation when all the movable distances of the movement trajectories are less than the movable distance of the current movement trajectory of the movable platform.

The movable device provided in this embodiment can execute the assisted movement method provided in the foregoing embodiments, and its execution method and beneficial effects are similar, and details are not described herein again.

An embodiment of the present disclosure further provides a movable platform. The movable platform includes a body, a power system disposed on the body for providing power for the movable platform, and the movable device provided in the above embodiment.

In some embodiments, the movable platform may also include a sensor disposed on the body for detecting and obtaining map information of the environment in which the movable platform is positioned.

In some embodiments, the sensor may include a vision sensor and/or a distance sensor.

In some embodiments, the movable platform may further include a communication device disposed on the body and used to exchange information with the ground station.

In some embodiments, the movable platform may include at least one of a UAV and an automobile.

The execution method and beneficial effects of the movable platform provided in this embodiment are similar to those of the movable device provided in the foregoing embodiment, and will not be repeated here.

In the several embodiments provided by the present disclosure, it should be understood that the disclosed apparatus and method may be implemented in other manners. For example, the apparatus embodiments described above are merely illustrative. For example, the unit division is merely logical function division and there may be other division in actual implementation. For example, multiple units or components may be combined or integrated into another system, or some features can be omitted or not be executed. In addition, the mutual coupling or the direct coupling or the communication connection as shown or discussed may be indirect coupling or communication connection through some interfaces, devices or units, and may be in electrical, mechanical or other forms.

The units described as separate components may or may not be physically separated. The components displayed as units may or may not be physical units, that is, may be located in one place or may also be distributed to multiple network units. Some or all of the units may be selected according to actual needs to achieve the objectives of the solution in the disclosure.

In addition, each functional unit in each embodiment of the present disclosure may be integrated into one processing unit, or each unit may exist alone physically, or two or more units may be integrated in one unit. The above-mentioned integrated unit can be implemented in the form of hardware or in the form of hardware plus software functional unit.

The above-described integrated unit implemented in the form of a software functional unit may be stored in a computer-readable storage medium. The software function unit is stored in a storage medium and includes several instructions for enabling a computer device (which may be a personal computer, a server, a network device, etc.) or a processor to execute some steps of the method according to each embodiment of the present disclosure. The foregoing storage medium includes a medium capable of storing program code, such as a USB flash disk, a removable hard disk, a read-only memory (ROM), a random access memory (RAM), a magnetic disk, an optical disc, or the like.

Those skilled in the art may clearly understand that, for convenience and brevity of description, the division of the foregoing functional modules is only used as an example. In practical applications, however, the above function allocation may be performed by different functional modules according to actual needs. That is, the internal structure of the device is divided into different functional modules to accomplish all or part of the functions described above. For the working process of the foregoing apparatus, reference may be made to the corresponding process in the foregoing method embodiments, and details are not described herein again.

Finally, it should be noted that the foregoing embodiments are merely intended for describing the technical solutions of the present disclosure, but not to limit the present disclosure. Although the present disclosure is described in detail with reference to the foregoing embodiments, it should be understood by those of ordinary skill in the art that the technical solutions described in the foregoing embodiments may still be modified, or a part or all of the technical features may be equivalently replaced without departing from the spirit and scope of the present disclosure. As a result, these modifications or replacements do not make the essence of the corresponding technical solutions depart from the scope of the technical solutions of the present disclosure.

1. An assisted movement method, comprising:
generating an obstacle avoidance assistance instruction in a user control mode when a distance to an obstacle is less than a predetermined distance range; and
controlling a movement trajectory of a movable platform based on a control instruction input by a user and the obstacle avoidance assistance instruction.

2. The assisted movement method of claim 1, wherein:
the obstacle avoidance assistance instruction is used to increase a speed component of the movable platform in a first direction, the first direction being perpendicular to a direction of the movable platform toward the obstacle.

3. The assisted movement method of claim 2, wherein:
the obstacle avoidance assistance instruction is used to reduce or offset the speed component of the movable platform toward the obstacle caused by the control instruction.

4. The assisted movement method of claim 2, wherein generating the obstacle avoidance assistance instruction in the user control mode when the distance to the obstacle is less than the predetermined distance range includes:
determining the movement trajectory of the movable platform that can bypass the obstacle based on the control instruction entered by the user and the obstacle avoidance assistance instruction in the user control mode when the distance to the obstacle is less than the predetermined distance range; and
generating the obstacle avoidance assistance instruction based on the movement trajectory and the control instruction.

5. The assisted movement method of claim 4, further comprising:
displaying a current movement trajectory of the movable platform and/or the movement trajectory of the movable platform that can bypass the obstacle.

6. The assisted movement method of claim 2, wherein generating the obstacle avoidance assistance instruction in the user control mode when the distance to the obstacle is less than the predetermined distance range includes:
generating one or more obstacle avoidance assistance instructions based on the control instruction entered by the user in the user control mode when the distance to the obstacle is less than the predetermined distance range.

7. The assisted movement method of claim 1, wherein controlling the movement trajectory of the movable platform based on the control instruction entered by the user and the obstacle avoidance assistance instruction includes:
controlling the movement trajectory of the movable platform based on a first control instruction currently entered by the user and the obstacle avoidance assistance instruction.

8. The assisted movement method of claim 1, wherein controlling the movement trajectory of the movable platform based on the control instruction entered by the user and the obstacle avoidance assistance instruction includes:
predicting a second control instruction that the user may input with a predetermined period of time after inputting the first control instruction; and
controlling the movement trajectory of the movable platform based on the second control instruction and the obstacle avoidance assistance instruction.

9. The assisted movement method of claim 2, wherein controlling the movement trajectory of the movable platform based on the second control instruction and the obstacle avoidance assistance instruction includes:
predicting one or more movement trajectory of the movable platform based on the first control instruction, the second control instruction, and the obstacle avoidance assistance instruction; and
controlling the movable platform to move based on one of the one or more movement trajectories.

10. The assisted movement method of claim 9, further comprising:
displaying the one or more movement trajectories.

11. The assisted movement method of claim 10, further comprising:
obtaining a user selection operation on the one or more movement trajectories; and
controlling the movable platform to move based on the movement trajectory selected by the user.

12.-18. (canceled)

19. A movable device comprising:
a memory storing program instructions; and
a processor configured to execute the program instructions that, when being executed by the processor, cause the processor to
generating an obstacle avoidance assistance instruction in a user control mode when a distance between a movable platform and an obstacle is less than a predetermined distance range; and
controlling a movement trajectory of the movable platform based on a control instruction input by a user and the obstacle avoidance assistance instruction.

20. The movable device of claim 19, wherein:
the obstacle avoidance assistance instruction generated by the processor is used to increase a speed component of the movable platform in a first direction, the first direction being perpendicular to a direction of the movable platform toward the obstacle.

21. The movable device of claim 20, wherein:
the obstacle avoidance assistance instruction generated by the processor is used to reduce or offset the speed component of the movable platform toward the obstacle caused by the control instruction.

22. The movable device of claim 20, wherein the processor generating the obstacle avoidance assistance instruction includes:
determining the movement trajectory of the movable platform that can bypass the obstacle based on the control instruction entered by the user and the obstacle avoidance assistance instruction in the user control mode when the distance between the movable platform and the obstacle is less than the predetermined distance range; and
generating the obstacle avoidance assistance instruction based on the movement trajectory and the control instruction.

23. The movable device of claim 22, wherein the processor is further configured to execute the program instructions to:
send a current movement trajectory of the movable platform and/or the movement trajectory of the movable platform that can bypass the obstacle to a ground station for display.

24. The movable device of claim 20, wherein the processor generating the obstacle avoidance assistance instruction includes:
generating one or more obstacle avoidance assistance instructions based on the control instruction entered by the user in the user control mode when the distance between the movable platform and the obstacle is less than the predetermined distance range.

25. The movable device of claim 19, wherein the processor controlling the movement trajectory of the movable platform based on the control instruction entered by the user and the obstacle avoidance assistance instruction includes:
controlling the movement trajectory of the movable platform based on a first control instruction currently entered by the user and the obstacle avoidance assistance instruction.

26. The movable device of claim 19, wherein the processor controlling the movement trajectory of the movable platform based on the control instruction entered by the user and the obstacle avoidance assistance instruction includes:
predicting a second control instruction that the user may input with a predetermined period of time after inputting the first control instruction; and
controlling the movement trajectory of the movable platform based on the second control instruction and the obstacle avoidance assistance instruction.

27. The movable device of claim 26, wherein the processor controlling the movement trajectory of the movable platform based on the second control instruction and the obstacle avoidance assistance instruction includes:
predicting one or more movement trajectory of the movable platform based on the first control instruction, the second control instruction, and the obstacle avoidance assistance instruction; and
controlling the movable platform to move based on one of the one or more movement trajectories.

28.-41. (canceled)
